(19) United States
(12) Patent Application Publication
(10) Pub. No.: US 2007/0137095 A1
(43) Pub. Date: Jun. 21, 2007

(54) Device and method for exterminating of fire ants using high-pressure heated gas pulses

(75) Inventor: Yang-Yuan Chen, Taipei (TW)

Correspondence Address: BACON & THOMAS, PLLC, 625 SLATERS LANE, FOURTH FLOOR, ALEXANDRIA, VA, 22314, US

(73) Assignee: Academia Sinica, Taipei (TW)

(21) Appl. No.: 11/304,666

(22) Filed: Dec. 16, 2005

(51) Int. Cl. A01M 1/20; A01M 17/00

(52) U.S. Cl. 43/132.1; 43/144

(57) ABSTRACT

Device and method for killing fire ants by the introduction of high-pressure heated gas pulses to the fire ant mound is disclosed. A metal hollowed probe having a couple of orifices near the bottom is mechanically or manually inserted into the fire ant mound. Heated gas in the metal hollowed probe is ejected in pulse from the orifices into the ant mound, going through channels in the mound, whereby the whole ant mound is filled with the heated gas rapidly. Fire ants and ant queens are killed by the heat before they move to safety. The invented device provides a fast and safe method for killing fire ants and ant queens without using any hazardous or toxic poisons.

### FIELD OF THE INVENTION

The present invention relates to device and method for exterminating fire ants by introducing high-pressure heated gas pulses into the fire ant mound.

### BACKGROUND OF THE INVENTION

In the recent years, fire ant invasion into several countries including Taiwan has brought about huge damages to the environment and even to the economy. In some regions fire ants have settled down and excluded domestic ants. According to some researches, fire ants have the following characteristics. First, when the ant mound is attacked by invaders, a large quantity of fire ants would rapidly fight back against invaders. Secondly, when the invasion is strong enough to destroy the ant mound, the fire ants would evacuate, carrying away ant queens, through the underground tunnels. Last but not least, if only a queen and a few fire ants survive, a new ant mound and new colony would be reestablished within a short time. As a result, any effective way to exterminate a colony of fire ant should be able to kill all fire ants including the ant queens immediately after the extermination activity commenced and the fire ants were alerted and before the fire ants and the queen successfully escaped.

Some methods for destruction of fire ants have been disclosed. U.S. Pat. No. 4,756,118 issued to Evans disclosed a method of extermination of fire ants by inserting a pipe into the ant mound and introducing steamed pesticide into the ant mound through the pipe. U.S. Pat. No. 5,054,231 issued to Witherspoon disclosed a method of extermination of fire ants by drowning the whole ant mound with pesticide solutions. These methods required direct contacts of pesticides or pesticide solutions with the fire ants and the ant queens. However, some fire ant colonies bury their ant queens at locations over one meter beneath the ground, a depth where pesticides or pesticide solution could not reach. In addition, pesticides tend to bring pollutions to the environment.

U.S. Pat. No. 5,031,355 issued to Ryan disclosed a method of extermination of fire ants by covering the ant mound with a tent and introducing heated steams into the ant mound to kill all ants. U.S. Pat. No. 6,026,609 issued to Rawls further disclosed a modification by inserting a pipe into the ant mound and introducing heated steams into the ant mound through the pipe. These methods required heated steam, killing the fire ants with high temperature. However, after the steam was introduced into the ant mound it would condensate into liquid which would block the tunnels. Further supplied steam is thus not able to enter into the tunnel to reach terminals of the tunnels. Repeating the process could not ensure extermination of all fire ants.

U.S. Pat. No. 5,165,199 issued to Tallon disclosed a method of extermination of fire ants with refrigerants or coolants such as liquid nitrogen. Liquid nitrogen with the temperature of −196° C. could effectively freeze all fire ants in the mound. However, liquid nitrogen is difficult to carry and operate. Thermal insulation container is needed to store and transport liquid nitrogen. In addition, to introduce liquid nitrogen into the ant mound requires thermal insulation pipes. As the equipments are complicated and expensive, this method was not popular due to its high cost and inconvenience in operation.

U.S. Pat. No. 2,114,494 issued to Hummel et al. disclosed a method for killing micro organisms and insects by spreading heated air to carpet indoors. This method, however, is only effective for killing micro organisms and insects that are exposed to the air. For fire ants that hide deep in the ground, such method was useless.

Although the conventional art provided several methods to kill fire ants, they are either expensive and complicated or difficult to introduce steam, heated air or pesticides deep into the ant mound. It is thus necessary to provide a novel device and method for extermination of fire ants that is inexpensive, effective and easy to operate.

### OBJECTIVES OF THE INVENTION

The objective of the present invention is to provide a novel method for extermination of fire ants.

Another objective of the invention is to provide a new device for extermination of fire ants.

Another objective of this invention is to provide a method for extermination of fire ants that is inexpensive, effective and easy to operate.

Another objective of this invention is to provide a device for extermination of fire ants that is inexpensive, effective and easy to operate.

Another objective of this invention is to provide a method for extermination of fire ants using high-pressure, heated gas pulses.

Another objective of this invention is to provide a device for extermination of fire ants using high-pressure, heated gas pulses.

### SUMMARY OF THE INVENTION

According to this invention, a device for extermination of fire ants using high-pressure heated gas pulses is provided. The device for extermination of fire ants comprises a hollowed metal pipe to introduce high-pressure heated gas into the ant mound. A gas inlet is provided in the pipe, through which high-pressure gas enters into the pipe under the control of a gas flow controller. At the lower end of the pipe, a plurality of gas outlets is provided, through which high-pressure heated gas is introduced into the ant mound. The diameter of the upper part of the pipe may be greater, to encapsulate electric heaters to heat the gas inside the pipe. The lower end of the pipe may have a conic shape, to reduce obstacles when inserting the metal pipe into the ant mound. A seal may be provided at the lower end of the pipe to seal up the gap between the pipe and the ant mound.

The method for extermination of fire ants of this invention comprises the following steps: Heaters of the metal pipe are first connected to power supply. The gas flow control valve of the metal pipe is then connected with a high-pressure gas container. The metal pipe is inserted or hammed into the ant mound, so that the lower end of the metal pipe reaches the deep end of the ant mound. Turn on and off the gas control valve intermittently to introduce the heated gas into the ant mound, while at the same time enables gas inside the metal pipe to have sufficient time for heating and maintaining higher temperature. The heated gas is introduced into the ant mound from its deepest site and ascends upward to fill up all tunnels of the ant mound, killing all the fire ants.

These and other objectives and advantages of this invention may be clearly understood from the detailed description by referring to the following drawings.

### BRIEF DESCRIPTION OF THE DRAWINGS

FIG. 1 illustrates the structural diagram of the device for extermination of fire ants of this invention.

FIG. 2 shows the structure of the metal pipe of the device for extermination of fire ants using high-pressure heated gas pulses of this invention.

### DETAILED DESCRIPTION OF THE DRAWINGS

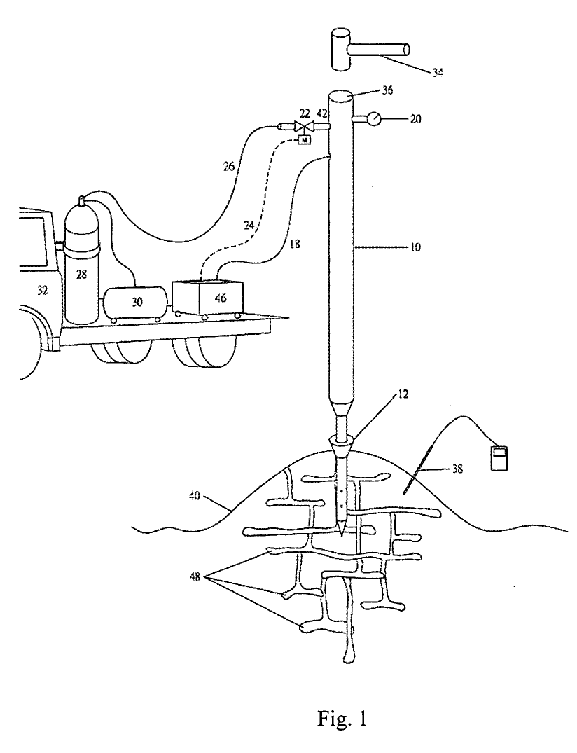

FIG. 1 illustrates the structural diagram of the device for extermination of fire ants of this invention. As shown in this figure, the device for extermination of fire ants using high-pressure heated gas pulses of this invention comprises a hollowed metal pipe 10, to introduce high-pressure heated gas into the red ant mound 40. The pipe 10 may be made from any hard and heat-resistant material, such as metals. A gas inlet 42 is provided at the top end of the pipe 10. A gas flow controller, such as an electric valve 22, is provided to control entrance of high-pressure gas into the pipe 10. A pressure gauge 20 is optionally provided in the pipe 10, to monitor gas pressure inside the pipe 10. A flexible pressure-resistant pipe 26 connects the electric valve 22 and a high-pressure gas container 28, to introduce high-pressure gas from the high-pressure gas container 28 into the metal pipe 10. Compressor 30 supplies high-pressure gas into the high-pressure gas container 28, to maintain gas pressure in the container 28. Gas used in this invention may be air or any non-hazardous gas, such as nitrogen, oxygen, carbon dioxide, water vapor etc. One or more thermometers 38 may be optionally provided around the ant mound 40 to monitor the temperature inside the ant mound 40.

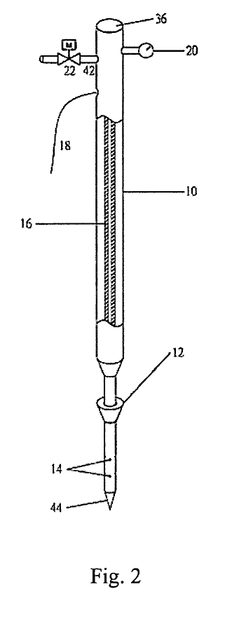

FIG. 2 shows the structure of the metal pipe 10. As shown in this figure, the metal pipe 10 has a solid cap 36 on its top to bear the hamming shocks of hydraulic presser or hammer 34, when inserting the metal pipe 10 into the ant mound 40. Diameter of the upper portion of the metal pipe 10 is made greater, so to contain a pipe heater 16 inside the metal pipe 10. Power for the pipe heater 16 is supplied by power supply lead 18. At the lower end of the metal pipe 10, a plurality of orifices 14 are provided to introduce high-pressure heated gas into the ant mound 40 from the metal pipe 10. The lower end of the metal pipe 10 may have a conic shape 44 to reduce obstacles when the metal pipe 10 is inserted into the ant mound 40. An additional air seal 12 may be provided at lower part of the metal pipe 10, to seal up gaps between metal pipe 10 and the ant mound 40, so to prevent leakage of the heated gas.

When using the device for extermination of fire ants using high-pressure heated gas pulses of this invention, pipe heater 16 in the metal pipe 10 is first connected to the power supply lead 18. The electric valve 22 of the metal pipe 10 is also connected to the high-pressure gas container 28 with the flexible pressure-resistant pipe 26. The metal pipe 10 is then inserted into the ant mound 40 using a hydraulic presser or the hammer 34, so that the lower end of the metal pipe 10 reaches the deepest of the ant mound 40. Turn on the power supply 46 of the pipe heater 16 to heat the gas inside the metal pipe 10. Time needed for the heating depends on conditions such as volume of gas inside the metal pipe 10, power of the pipe heater 16 and temperature needed. Heating time may be in the range from several seconds to several minutes. Power of the pipe heater 16 may vary from hundreds Watts to thousands Watts, both depending on size of the ant mound 40. Generally speaking, when a heater of the power of 5,000 Watts is used to exterminate an ant mound with the diameter of 50 cm, about several tens of minutes are needed to heat the high-pressure gas. Due to the fact that heated gas would ascend physically, it is preferably that the high-pressure heated gas is introduced into the ant mound from its bottom.

When the gas inside the pipe heater 16 reaches a predetermined temperature, turn on the electric valve 22 to introduce gas stored in the high-pressure gas container 28 into the metal pipe 10, to force the heated gas into the ant mound 40. Air pressure in the high-pressure gas container 40 may range from several ATM to tens of ATMs. Generally speaking, the greater the pressure of the heated gas is, the easier the heated gas is introduced into the ant mound 40.

One or more thermometers 38 may be inserted around the ant mound 40 to monitor the temperature in the ant mound 40, and its temperature variations. The electric valve 22 may be turned on and off intermittently to generate pulses of high-pressure heated gas. Such operation may also give the air inside the metal pipe 10 sufficient time for heating and for maintaining in higher temperature. Frequency and cycle of the electric valve 22 may be so controlled that desired temperature of the gas is obtained. Such approach may also help to save high-pressure gas consume. A pressure gauge 20 may be provided in the metal pipe 10 to provide references for the temperature of the heated gas. Generally speaking, pressure of the heated gas may range from several ATMs to several tens of ATMs. Higher pressure ensures better extermination effects.

In general, the control valve may be turned on for tens of seconds to several minutes, depending on temperature of the ant mound 40 as measured by the thermometer 38. Experiment shows that no fire ant can survive under over 60° C. Accordingly, there is a great space of tolerance for various physical parameters in the operation of the device for extermination of fire ants using high-pressure heated gas pulses of this invention, such as pressure and heating time of the heated gas, operation cycle of the control valve etc. To ensure the extermination of the fire ants, preferably temperature of the heated gas is increased and heating time is made longer.

Temperature of heated gas being introduced into the ant mound may be adjusted by controlling the operation cycle of the electric valve 22. Basically, when the valve 22 is closed for a longer time, the heated gas is made hotter, since it is heated for a longer time. On the other hand, when the valve 22 is opened for a longer time, temperature of the heated gas would be lower.

### Effects of the Invention

From the above description, it may be understood that features of the invented device for extermination of fire ants include the followings:
1. The metal pipe having gas outlets is inserted into the ant mound and high-pressure heated gas is then introduced into the ant mound.
2. Inside the metal pipe, a pipe heater is provided to directly heat the gas inside the pipe. Operation of the invented device for extermination of fire ants is made easy and convenient.
3. An air pressure that is higher than that in the ant mound is used to pump heated gas into the sealed space of the mound, whereby the heated gas may rapidly fill up all connected tunnels of the ant mound. Operation time for the red ant extermination action was made short. Heated gas may flood in the whole ant mound within a very short time. Fire ants are killed before they could escape.
4. Optionally a thermometer may be used to monitor the temperature of the ant mound to ensure that all fire ants and their queens are definitely killed.

In addition to the above-described advantages in operation of the invented device for extermination of fire ants using high-pressure heated gas pulses of this invention, the present invention is advantageous over the prior art in the following aspects:
1. The invented device is light and compact. It may be transported using an ordinary vehicle 32. No special requirements are needed.
2. The pipe heater 16 is provided inside the metal pipe 10. High-pressure gas may be heated inside the metal pipe 10, ensuring that the high temperature is limited to inside and adjacent the metal pipe 10. Safety in operation is thus ensured.
3. Since the gas is heated inside the metal pipe 10, which is inside the ant mound 40, losses in thermal energy is thus prevented due to the short distance in transporting the heated gas to the ant mound. Wastes in energy are thus eliminated.
4. The metal pipe 10 is inserted into the ant mound with a hydraulic presser or a hammer. Mechanical or manual insertion of the metal pipe 10 may be selectively used.
5. The heated gas is introduced into the ant mound with high pressure and floods into every tunnel 48 of the mound. Fire ants are killed before they could escape.
6. No supply wearing components or materials is needed, except the electric power. It is thus possible to use the invented device to exterminate a plurality of red ant mounds in one operation.
7. Heated gas used to kill fire ants may be the air or non-toxic gas such as nitrogen or oxygen. No pollutions would be brought to the environment.

As the present invention has been shown and described with reference to preferred embodiments thereof, those skilled in the art will recognize that the above and other changes may be made therein without departing form the spirit and scope of the invention.

What is claimed is:

1. Device for extermination of fire ants, comprising a hollowed longitudinal pipe to introduce high-pressure heated gas into fire ant mound; wherein said pipe is provided with a gas inlet and a gas flow controller to control gas flow into said pipe and a plurality of gas orifices at lower end thereof to allow said high-pressure heated gas to enter into said fire ant mound.

2. The device for extermination of fire ants according to claim 1, wherein said pipe has a conic shape at its lower end to reduce obstacles when said pipe is inserted into said fire ant mound.

3. The device for extermination of fire ants according to claim 1, further comprising a compressor to generate high-pressure gas to be supplied to said hollowed pipe.

4. The device for extermination of fire ants according to claim 3, further comprising a high-pressure gas container to store high-pressure gas generated by said compressor.

5. The device for extermination of fire ants according to claim 1, wherein said pipe has a enlarged diameter at its upper portion, wherein a pipe heater is provided to heat gas inside said pipe.

6. The device for extermination of fire ants according to claim 1, wherein said pipe is further provided a gas seal to seal gaps between said pipe and said fire ant mound when said pipe is inserted therein.

7. The device for extermination of fire ants according to claim 1, wherein said pipe has a greater diameter in its upper portion and a smaller diameter in its lower portion.

8. The device for extermination of fire ants according to claim 1, wherein said gas flow controller comprises an electric valve, through which high-pressure gas stored in said high-pressure gas container may be introduced into said pipe.

9. The device for extermination of fire ants according to claim 8, wherein said electric valve so controls entrance of said high-pressure gas into said pipe that said high-pressure gas enters into said fire ant mound in pulses.

10. The device for extermination of fire ants according to claim 1, further comprising a pressure gauge provided adjacent to said inlet of said pipe to measure gas pressure inside said pipe.

11. The device for extermination of fire ants according to claim 1, further comprising a solid cap on top of said pipe to bear shocks from external.

12. The device for extermination of fire ants according to claim 1, further comprising at least one thermometer to be located around said red ant mound.

13. Method for extermination of fire ants, comprising the steps of:
generating high-pressure gas using a compressor;
storing said high-pressure gas in a high-pressure gas container;
connecting said high-pressure gas container to gas flow controller of a pipe with a pressure-resistant pipe;
inserting said pipe into an ant mound;
supplying electric power to pipe heater in said pipe to heat gas inside said pipe; and
turning on said gas flow controller to introduce high-pressure gas in said high-pressure gas into said pipe and then to said ant mound.

14. The method for extermination of fire ants according to claim 13, further comprising the step of inserting a seal from upper portion of said pipe to seal gaps between said pipe and said ant mound.

15. The method for extermination of fire ants according to claim 13, further comprising the step of turning on and off said gas flow controller intermittently to generate periodical increase and decrease of gas pressure inside said ant mound.

16. The method for extermination of fire ants according to claim 13, wherein said gas flow controller comprises an electric valve.

17. The method for extermination of fire ants according to claim 16, further comprising the step of controlling open time period or close time period of said electric valve to control temperature of high-pressure gas introduced into said ant mound.

18. The method for extermination of fire ants according to claim 16, further comprising the step of maintaining temperature inside said ant mound at over 60° C. for a predetermined period of time.

19. The method for extermination of fire ants according to claim 16, further comprising the step of controlling the open and close operations of said electric valve according to readings of a pressure gauge provided in said pipe.
